(19) United States
(12) Patent Application Publication
(10) Pub. No.: US 2004/0118658 A1
(43) Pub. Date: Jun. 24, 2004

(54) Multiple-pass item processing system and method of operating a multiple-pass item processing system to match document items

(75) Inventors: Susan H. Schott, Waterloo (CA); James W.D. Fare, Waterloo (CA); Kenneth G. De Souza, Kitchener (CA); Sean Woodward, Waterloo (CA)

Correspondence Address: Michael Chan, NCR Corporation, 1700 South Patterson Blvd., Dayton, OH, 45479-0001, US

(73) Assignee: NCR Corporation

(21) Appl. No.: 10/325,342

(22) Filed: Dec. 19, 2002

(51) Int. Cl. G07F 7/02; G06F 17/00

(52) U.S. Cl. 194/210; 235/375; 705/45; 382/137

(57) ABSTRACT

A multiple-pass item processing system has an image capture workstation for processing checks during a first pass of checks and an encoding and sorting workstation for processing checks during a second pass of checks. Radio frequency identification (RFID) tag data including a unique RFID tag number is extracted from an RFID tag of a check transported along a check transport path of the image capture workstation during the first pass. The unique RFID tag number extracted during the first pass is stored in a memory. RFID tag data including a unique RFID tag number is extracted from an RFID tag of a check transported along a check transport path of the encoding and sorting workstation during the second pass. The unique RFID tag number extracted during the second pass is compared with RFID tag number store in the memory to determine if there is a match.

### BACKGROUND OF THE INVENTION

The present invention relates to multiple-pass item processing systems, and is particularly directed to a method of operating a multiple-pass item processing system, such as a multiple-pass image-based check processing system, to match document items.

A typical multiple-pass image-based check processing system includes an image capture workstation which captures images of document items during a first pass of document items, and an encoding and sorting workstation which encodes and sorts document items during a second pass which is after the first pass. The image capture workstation includes an image capture item processing transport which has a document transport path and a number of different hardware devices lying along the document transport path for performing specific document processing operations on document items moving downstream along the document transport path. Hardware devices lying along the document transport path usually include one imaging camera disposed on one side of the document transport path for capturing an image of the frontside of a document item and another imaging camera disposed on the other side of the document transport path for capturing an image of the backside of the document item as the document item moves downstream along the document transport path. The image capture workstation also includes an image capture transport processor which executes an image capture transport application program which is stored in memory to control operation of the hardware devices lying along the document transport path and thereby to control operation of the image capture item processing transport. The image capture item processing transport includes a plurality of pockets located at the downstream end of the document transport path. Each processed document item is directed into one of the pockets.

The encoding and sorting workstation includes an encoding and sorting item processing transport which has a document transport path and a number of different hardware devices lying along the document transport path for performing specific document processing operations on document items moving downstream along the document transport path. Hardware devices lying along the document transport path usually include an encoder disposed on one side of the document transport path for encoding magnetic ink character recognition (MICR) information onto the frontside of a document item as the document item moves downstream along the document transport path. The encoding and sorting workstation also includes an encoding and sorting transport processor which executes an encoding and sorting transport application program which is stored in memory to control operation of the hardware devices lying along the document transport path and thereby to control operation of the encoding and sorting item processing transport. The encoding and sorting item processing transport includes a plurality of pockets located at the downstream end of the document transport path. Each processed document item is sorted and directed into one of the pockets.

Before the MICR information can be encoded onto the document items during the second pass of document items on the encoding and sorting item processing transport, each physical document item needs to be matched with its corresponding data captured during the first pass of the document item on the image capture item processing transport. If a physical document item during the second pass is not matched with its corresponding data captured during the first pass, then incorrect MICR information will be encoded onto that physical document item. Any occurrence of a mismatch condition is costly because much time and effort are required to correct all of the document items involved when such a condition occurs. Accordingly, it is necessary to provide a multiple-pass image-based check processing system which ensures accuracy and reliability in matching physical document items of a subsequent pass of document items with their corresponding data from a previous pass.

### SUMMARY OF THE INVENTION

In accordance with one aspect of the present invention, a multiple-pass item processing system has an image capture workstation for processing checks during a first pass of checks and an encoding and sorting workstation for processing checks during a second pass of checks. The system comprises first extracting means for extracting RFID tag data from an RFID tag of a check transported along a check transport path of the image capture workstation during the first pass, and storing means for storing RFID tag data extracted during the first pass. The system further comprises second extracting means for extracting RFID tag data from an RFID tag of a check transported along a check transport path of the encoding and sorting workstation during the second pass, and means for comparing the RFID tag data extracted during the second pass with RFID tag data stored in the storing means to determine if there is a match.

Preferably, the first extracting means includes means for extracting RFID tag data including a unique RFID tag number associated with the particular check transported along the check transport path of the image capture workstation during the first pass, and the second extracting means includes means for extracting RFID tag data including a unique RFID tag number associated with the particular check transported along the check transport path of the encoding and sorting workstation during the second pass. The first extracting means comprises an RFID tag data extracting program, and the second extracting means and the comparing means comprises an RFID tag data matching program.

In accordance with another aspect of the present invention, a method of operating a multiple-pass item processing system having an image capture workstation for processing checks during a first pass of checks and an encoding and sorting workstation for processing checks during a second pass of checks comprises the steps of (a) extracting RFID tag data from an RFID tag of a check transported along a check transport path of the image capture workstation, (b) extracting RFID tag data from an RFID tag of a check transported along a check transport path of the encoding and sorting workstation, and (c) comparing the extracted RFID tag data from the encoding and sorting workstation with the extracted RFID tag data from the image and capture workstation to determine if there is a match. The method may further comprise the step of (d) storing the extracted RFID tag data from the image capture workstation in an RFID tag data memory. The extracted RFID tag data from the RFID tag of the check transported along the check transport path of the image capture workstation comprises a unique RFID tag number associated with that particular check. The extracted RFID tag data from the RFID tag of the check transported along the check transport path of the encoding and sorting workstation comprises a unique RFID tag number associated with that particular check. The unique RFID tag number from the encoding and sorting workstation is compared with the unique RFID tag number from the image capture workstation.

In accordance with still another aspect of the present invention, a multiple-pass item processing system for processing checks comprises an image capture workstation including (i) means defining a first check transport path along which checks can be transported from an upstream end to a downstream end during a first pass, (ii) a first radio frequency identification (RFID) tag reader disposed along the first check transport path for transmitting interrogating signals toward an RFID tagged check transported along the first check transport path and receiving RFID tag data including a unique RFID tag number from an RFID tag of the check transported along the first check transport path when the check receives an interrogating signal from the first RFID tag reader. The system further comprises an encoding and sorting workstation including (i) means defining a second check transport path along which checks can be transported from an upstream end to a downstream end, (ii) a second RFID tag reader disposed along the second check transport path for transmitting interrogating signals toward an RFID tagged check transported along the second check transport path and receiving RFID tag data including a unique RFID tag number from an RFID tag of the check transported along the second check transport path when the check receives an interrogating signal from the second RFID tag reader.

Preferably, the image capture workstation includes an RFID tag data extracting application program for enabling the first RFID tag reader disposed along the first check transport path to transmit interrogating signals toward the RFID tagged check transported along the first check transport path and to receive RFID tag data from the RFID tag of the check transported along the first check transport path when the check receives an interrogating signal from the first RFID tag reader, and thereby to extract RFID tag data from the check. The encoding and sorting workstation includes an RFID tag data extracting application program for (i) enabling the second RFID tag reader disposed along the second check transport path to transmit interrogating signals toward the RFID tagged check transported along the second check transport path and to receive RFID tag data from the RFID tag of the check transported along the second check transport path when the check receives an interrogating signal from the second RFID tag reader, and thereby to extract RFID tag data from the check, and (ii) comparing the extracted RFID tag data with RFID tag data which has been extracted on the first pass at the image capture workstation.

In accordance with yet another aspect of the present invention, an encoding and sorting workstation of a multiple-pass item processing system comprises means defining a document transport path along which document items can be transported from an upstream end to a downstream end, and a radio frequency identification (RFID) tag reader disposed along the document transport path. The RFID tag reader includes (i) means for transmitting an interrogating signal towards an RFID tagged document item transported along the document transport path, (ii) means for receiving RFID tag data including a unique RFID tag number from an RFID tag of the document item transported along the document transport path when the RFID tag of the document item receives the interrogating signal, and (iii) means for matching the unique RFID tag number with a unique RFID tag number which has been previously captured at a different workstation. Preferably, the matching means comprises an RFID tag data matching program.

In accordance with another aspect of the present invention, a method of operating an encoding and sorting workstation of a multiple-pass item processing system comprises the steps of transmitting an interrogating signal towards an RFID tag of a document item transported along a document transport path, receiving RFID tag data including a unique RFID tag number from the RFID tag of the document item transported along the document transport path when the RFID tag of the document item receives the interrogating signal, and determining if the unique RFID tag number matches a unique RFID tag number which has been previously extracted at a different workstation of the multiple-pass document item processing system.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a diagram illustrating physical document item workflow in a multiple-pass image-based check processing system embodying the present invention;

FIG. 2 is a schematic block representation of the multiple-pass image-based check processing system of FIG. 1;

FIG. 3 is a schematic block representation of an image capture workstation in the system of FIG. 1 and showing certain details;

FIG. 4 is another schematic block representation of the image capture workstation of FIG. 3 and showing other details;

FIG. 5 is a diagram of a check having a radio frequency identification (RFID) tag;

FIG. 6 is a flowchart depicting operation of an image capture transport application program carried out at the image capture workstation of FIGS. 3 and 4;

FIG. 7 is a schematic block representation of an encoding and sorting workstation in the system of FIG. 1 and showing certain details;

FIG. 8 is a schematic block representation of the encoding and sorting workstation of FIG. 7 and showing other details; and

FIG. 9 is a flowchart depicting operation of an encoding and sorting transport application program carried out at the encoding and sorting workstation of FIGS. 7 and 8.

### DETAILS OF THE INVENTION

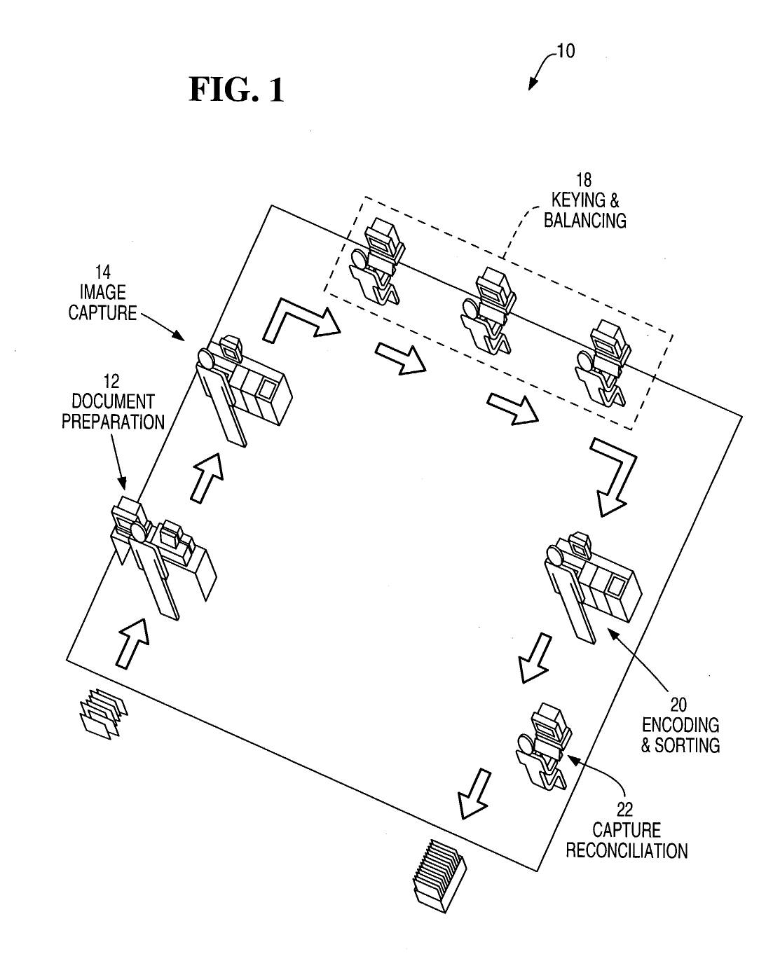

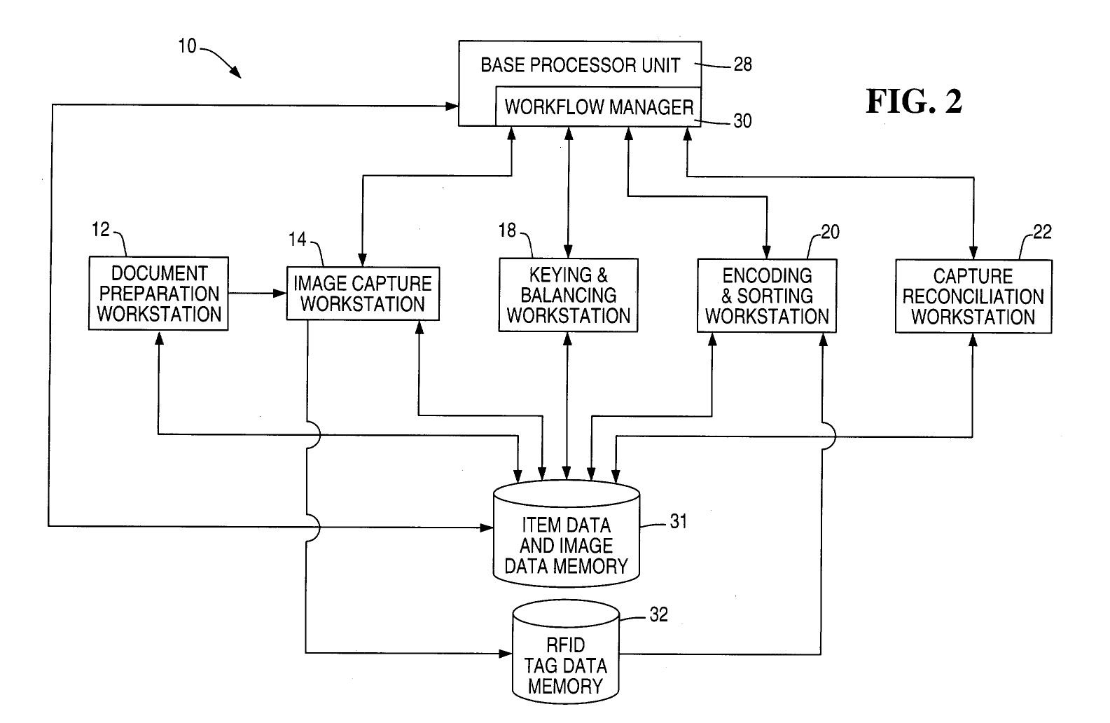

The present invention is directed to a multiple-pass item processing system and a method of operating a multiple-pass item processing system to match document items. The specific construction and use of the multiple-pass item processing system may vary. By way of example, a multiple-pass item processing system in the form of a multiple-pass image-based check processing system 10 is illustrated in FIGS. 1 and 2.

The multiple-pass image-based check processing system 10 comprises different types of workstations. The workstations may include a document preparation workstation 12, an image capture workstation 14, a recognition workstation (not shown), a keying and balancing workstation 18, an encoding workstation 20, and a capture reconciliation workstation 22. At the document preparation workstation 12, transaction items including a number of debit items and a number of credit items associated with each transaction are prepared for further processing downstream from the document preparation workstation 12. Typical transaction items include checks, deposit slips, and carrier documents (i.e., envelopes) which carry damaged checks. Preparation of the transaction items may include removal of paper clips, staples, and the like, and stacking of the items in a particular order and/or direction in suitable trays. The trays containing the stacked items are then manually carted to the image capture workstation 14.

The image capture workstation 14 creates units of work and submits the created work to a workflow manager 30 in a known way. Preferably, the image capture workstation 14 includes the Model iTRAN 8000 Item Processing System, manufactured by NCR Corporation, located in Dayton, Ohio. As shown in FIG. 1, the workflow manager 30 resides in non-volatile memory in a base processor unit 28 of the image-based check processing system 10. Each of the workstations 16, 18, 20, 22 polls the workflow manager 30 in a known manner for work to perform, and may also create units of work which is submitted back to the workflow manager 30. A first memory unit 31 stores item data and image data memory 31, and a second memory unit 32 stores radio frequency identification (RFID) tag data in a manner to be described later. Although the first and second memory units 31, 32 are shown as being separate units, it is contemplated that the memory units may comprise a single memory unit.

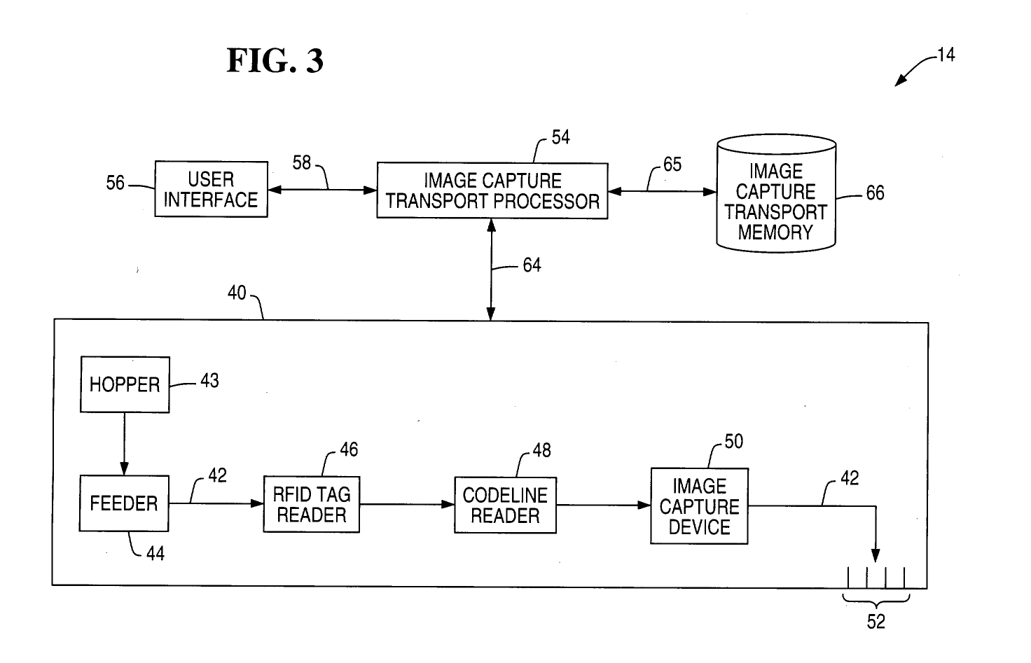

Referring to FIG. 3, the image capture workstation 14 includes an image capture item processing transport 40 having a document track which defines a document transport path 42 along which financial document items, such as checks, can be transported from an upstream end to a downstream end. The image capture transport 40 includes a number of different hardware devices lying along the document transport path 42 for performing specific document processing operations on document items moving along the document transport path. The image capture transport 40 includes a document hopper 43 into which a stack of financial document items including checks are placed. More specifically, the stacked items in the trays are manually removed from the trays and placed into the document hopper 43. A transport mechanism (not shown) picks items one-by-one from the document hopper 43 and transports the picked items along the document transport path 42 in a known manner. Each device lying along the document transport path 42 processes each document item transported along the document transport path in a manner described hereinbelow.

A document feeder 44 adjacent the document hopper 43 selectively feeds or drives each document item from the stack of items in the hopper to transport the document item from the upstream end to the downstream end along the document transport path 42. The document item is transported past each device along the document transport path 42 and eventually into one of a plurality of sorting bins 52 located at the end of the document transport path. The sorting bins 52 receive and pocket document items which have been processed along the document transport path 42 by the different devices. Accordingly, document items are moving from left to right (as viewed looking at FIG. 3).

The image capture transport 40 further includes an RFID tag reader 46. The RFID tag reader 46 may be of the type which emits radio waves at a predetermined frequency at a number of different times. The range of the emitted radio waves depend upon a number of different factors including the predetermined frequency used and the power output of the emitted radio waves, as is known. The range of the emitted radio waves is set so that a “read window” is created along a portion of the document transport path 42. The structure and operation of RFID tag readers are well known and, therefore, will not be described.

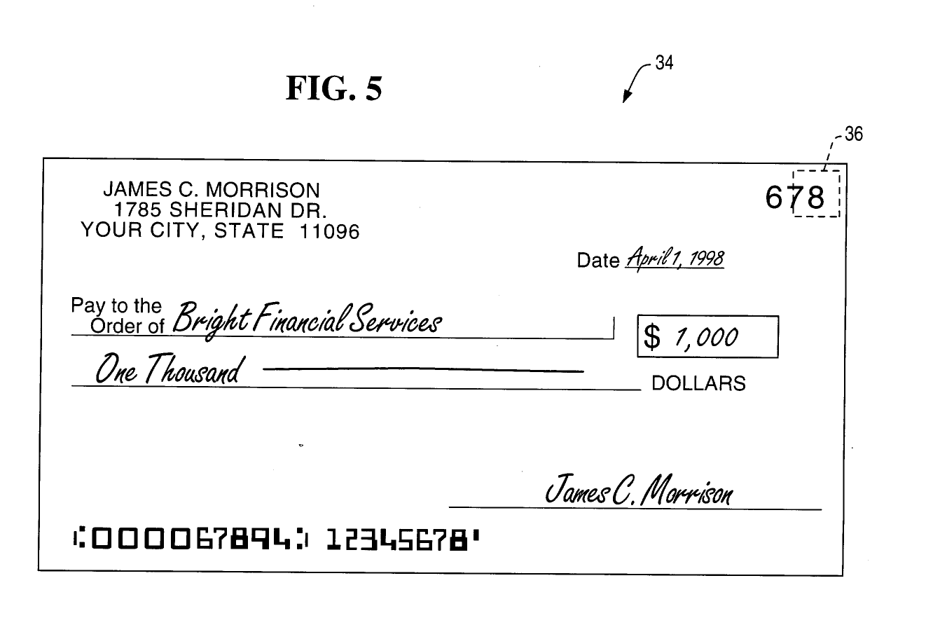

As shown in FIG. 5, a check 34 has an RFID tag 36 associated therewith. The check 34 with the RFID tag 36 may be constructed in many different ways. For example, the RFID tag 36 may be bonded to a major side surface of the check 34. As another example, the RFID tag 36 may be embedded into the sheet material of the check 34 during manufacture of the check. The RFID tag 36 includes RFID circuitry (not shown) and an RFID antenna (also not shown), as is known. The circuitry typically includes a printed circuit board on which electronic components are mounted. The antenna may be of the inductive loop type, for example. The structure and operation of the RFID tag 36 are well known and, therefore, will not be described.

A codeline reader 48, such as a MICR reader, located along the document transport path 42 reads a MICR codeline from each document item being processed in a known manner. Alternatively, the codeline reader may be an OCR reader instead of a MICR reader depending upon the particular application. An image capture device 50 located along the document transport path 42 includes an image lift camera (not shown) which is controlled to capture images of document items moving along the document transport path 42. More specifically, the image lift camera optically scans the front side of a document item as the document item moves along the document transport path past the image lift camera to produce a front electronic image of the document item. The front image of the document item is stored in the memory unit 31 (FIG. 1). Other items (deposit slips or control documents including batch headers, for example) are processed in the same manner. It is contemplated that a rear image lift camera may also be used to lift an image of the rear of the document item. For simplicity, it is assumed that only an image of the front side of a document item is lifted and processed. The structure and operation of MICR readers, OCR readers, and image capture devices are well known and, therefore, will not be described.

If the document item moving downstream along the document transport path 42 is a check, the MICR reader 48 reads a MICR codeline at the bottom of the check as the check passes by the MICR reader 48. Information from the MICR codeline of the check including a unique sequence number is associated with the front image of the check and is also stored in the memory unit 31. Accordingly, the front image of the check is stored in memory unit 31 along with a unique sequence number.

After the front image of the check is lifted by the image lift camera and the electronic image, the sequence number, and the MICR codeline are stored in the memory unit 31, the check is sorted into an appropriate one of the sorting bins 52. The sorted checks in each of the sorting bins 52 are stacked in a respective tray. The trays containing the stacked checks are then manually carted to the encoding workstation 20 (as shown in FIGS. 1, 7, and 8).

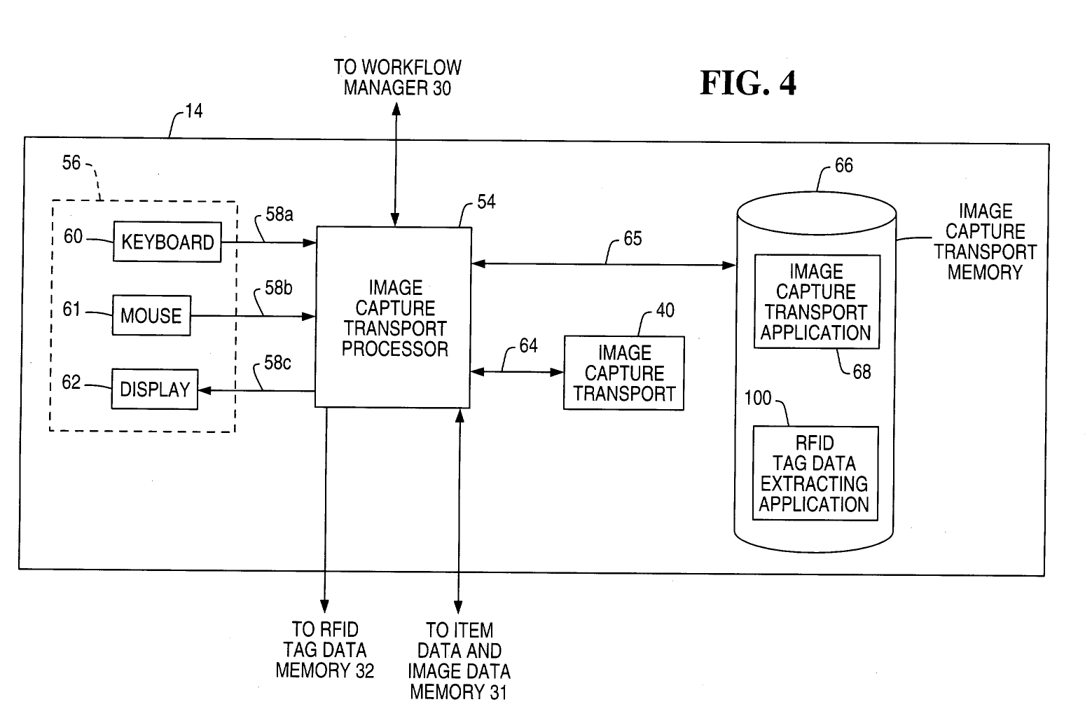

Referring to FIGS. 3 and 4, the image capture workstation 14 further includes an image capture transport processor 54 and an image capture transport user interface 56 which communicates via signals on line 58 (FIG. 3) with the image capture transport processor. The image capture transport user interface 56 includes a keyboard 60, a mouse 61, and a display 62, all of which communicate via signals on lines 58a, 58b, 58c (FIG. 4) with the image capture transport processor 54. The image capture transport processor 54 controls operation of the image capture transport 40 via signals on line 64. Suitable microcomputers and memories are readily available in the marketplace. Their structure and operation are well known and, therefore, will not be described.

The image capture workstation 14 also includes an image capture transport memory 66 which communicates via signals on line 65 with the image capture transport processor 54. It is contemplated that the image capture transport memory 66 could be a single memory unit or a plurality of different memory units. An executable image capture transport application program 68 is stored in the image capture transport memory 66. The image capture transport application program 68 is associated with a particular type of document processing work. For example, one type of work is proof of deposit. Another type of work is remittance processing. Still another type of work may be sorting of document items. When the image capture transport application program 68 is executed, the hardware devices lying along the document transport path 42 are controlled to process document items moving downstream along the document transport path in accordance with the image capture transport application program, as is known. The image capture transport memory 66 also stores an RFID tag data extracting program 100 in accordance with the present invention to be described in more detail hereinbelow.

The front electronic image, the sequence number, and the MICR codeline of the check 34 (FIG. 5) which were earlier obtained and stored in the memory unit 31 at the image capture workstation 14 is processed by the recognition workstation (not shown) and the keying and balancing workstation 18 in a known manner. Briefly, at the recognition workstation, the front electronic image of each check stored in the memory unit 31 is processed using known recognition techniques to determine the “amount” associated with the check. The amount of the check is then associated with the corresponding front electronic image and the MICR codeline of the check and stored in the memory unit 31. Amount keying, codeline completion, and balancing are performed, as needed, at the keying and balancing workstation 18, as is known. A one-to-one correspondence is thereby established between the front electronic image, the sequence number, the MICR codeline, and the amount associated with that particular check. Accordingly, a database containing the front electronic image, the sequence number, the MICR codeline, and the amount associated with each check is thereby created and stored in the memory unit 31.

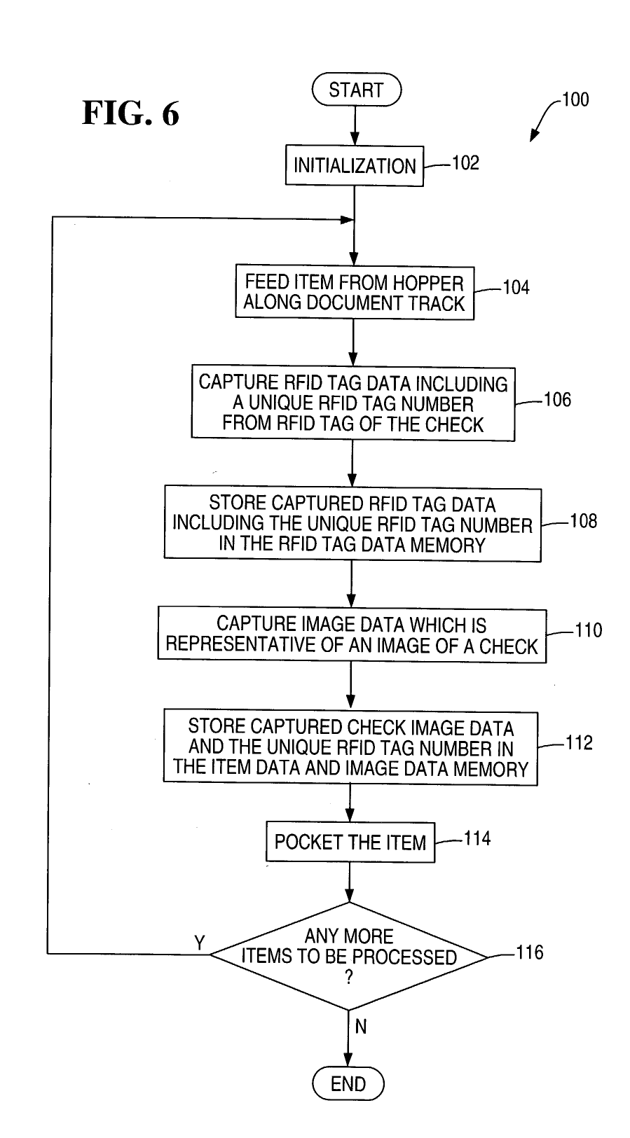

FIG. 6 is a flowchart which depicts operation of the image capture transport application program 100 which runs continuously as each document item is transported from the upstream end of the document transport path 42 towards the downstream end of the document transport path. After program initialization in step 102, the program proceeds to step 104 in which the document feeder 44 feeds document items from the document hopper 43 into the document transport path 42. As shown step 106, the RFID tag reader 46 captures RFID tag data including a unique RFID tag number from each RFID tagged check as the check is transported past the RFID tag reader. The unique RFID number for each check may comprise, for example, a 48-bit (or any other number of bit) number which is burned into a microchip of the RFID tag during manufacture of the RFID tag. Alternatively, the unique RFID number for each check may be written into either a write-once or a read/write chip during printing of the check, as another example. The captured RFID tag data is stored in the memory unit 32, as shown in step 108.

Then, in step 110, the image of the check is captured in the manner as described in detail hereinabove. The captured check image data and the unique RFID tag number which was captured in step 106 are stored in the memory unit 31, as shown in step 112. After the check image data is stored in the memory unit 31, the check is pocketed into one of the plurality of sorting bins 52 at the end of the document transport path 42. A determination is made in step 116 as to whether there are any more document items to be processed at the image capture workstation 14. If the determination is affirmative, the program returns to step 104 to process the next item in the same manner as just described hereinabove. The program ends if the determination in step 116 is negative.

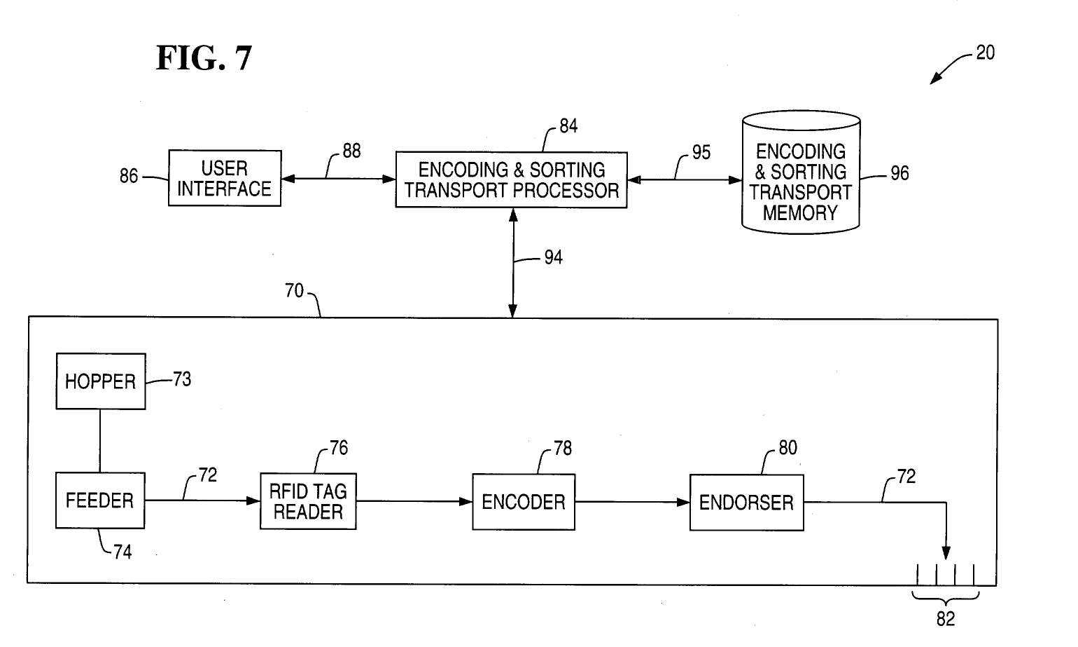

As previously mentioned, trays containing stacked checks which have been processed at the image capture workstation 14 are manually carted to the encoding and sorting workstation 20, as shown in FIGS. 1, 7, and 8. As shown in FIG. 7, the encoding and sorting workstation 20 includes an encoding and sorting item processing transport 70 having a document track which defines a document transport path 72 along which the checks can be transported from an upstream end to a downstream end. Preferably, the encoding and sorting item processing transport 70 also includes the Model iTRAN 8000 Item Processing System, manufactured by NCR Corporation, located in Dayton, Ohio. The encoding and sorting transport 70 includes a number of different hardware devices lying along the document transport path 72 for performing specific document processing operations on checks moving along the document transport path. The encoding and sorting transport 70 includes a document hopper 73 into which the stack of checks is placed. More specifically, the stacked checks in the trays are manually removed from the trays and placed into the document hopper 73. A transport mechanism (not shown) picks items one-by-one from the document hopper 73 and transports the picked items along the document transport path 72 in a known manner. Each device lying along the document transport path 72 processes each item transported along the document transport path in a manner described hereinbelow.

A document feeder 74 adjacent the document hopper 73 selectively feeds or drives each check from the stack of checks in the hopper to transport the check from the upstream end to the downstream end along the document transport path 72. The check is transported past each device along the document transport path 72 and eventually into one of a plurality of sorting bins 82 located at the end of the document transport path. The sorting bins 82 receive and pocket checks which have been processed along the document transport path by the different devices. Accordingly, checks are moving from left to right (as viewed looking at FIG. 7). The encoding and sorting transport 70 further includes an RFID tag reader 76 similar to the RFID tag reader 46 in the image capture transport 70. After the RFID tag reader 76 reads RFID tag data including the unique RFID tag number from each check, the RFID tag data including the unique RFID tag number is used in a manner to be described hereinbelow for the purpose of encoding information onto that particular check.

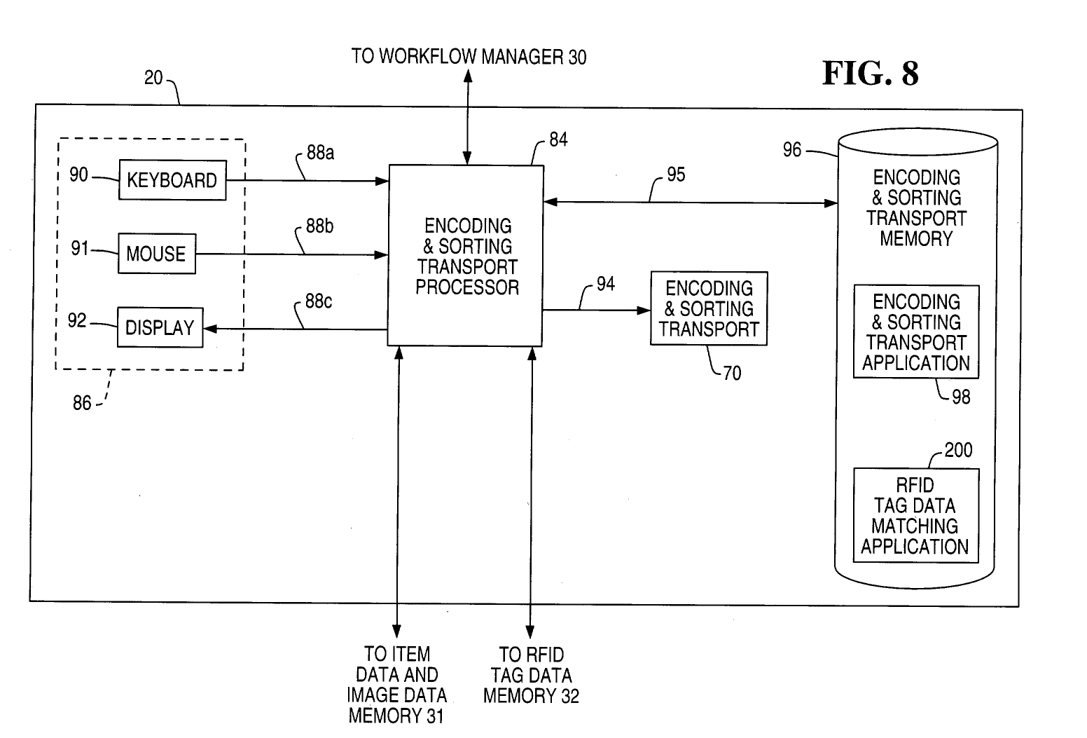

Referring to FIGS. 7 and 8, the encoding and sorting workstation 20 further includes an encoding and sorting transport processor 84 and an encoding and sorting transport user interface 86 which communicates via signals on line 88 (FIG. 7) with the encoding and sorting transport processor 84. The encoding and sorting transport user interface 86 includes a keyboard 90, a mouse 91, and a display 92, all of which communicate via signals on lines 88a, 98b, 98c (FIG. 8) with the encoding and sorting transport processor 84. The encoding and sorting transport processor 84 controls operation of the encoding and sorting transport 80 via signals on line 94. Suitable microcomputers and memories are readily available in the marketplace. Their structure and operation are well known and, therefore, will not be described.

The encoding and sorting workstation 20 also includes an encoding and sorting transport memory 96 which communicates via signals on line 95 with the encoding and sorting transport processor 84. It is contemplated that the encoding and sorting transport memory 96 could be a single memory unit or a plurality of different memory units. An executable encoding and sorting transport application program 98 is stored in the encoding and sorting transport memory 96. The encoding and sorting transport application program 98 is associated with a particular type of document processing work. When the encoding and sorting transport application program 98 is executed, the hardware devices lying along the document transport path 72 are controlled to process document items moving downstream along the document transport path in accordance with the encoding and sorting transport application program, as is known. The encoding and sorting transport memory 96 also stores an RFID tag data matching program 200 in accordance with the present invention to be described in more detail hereinbelow.

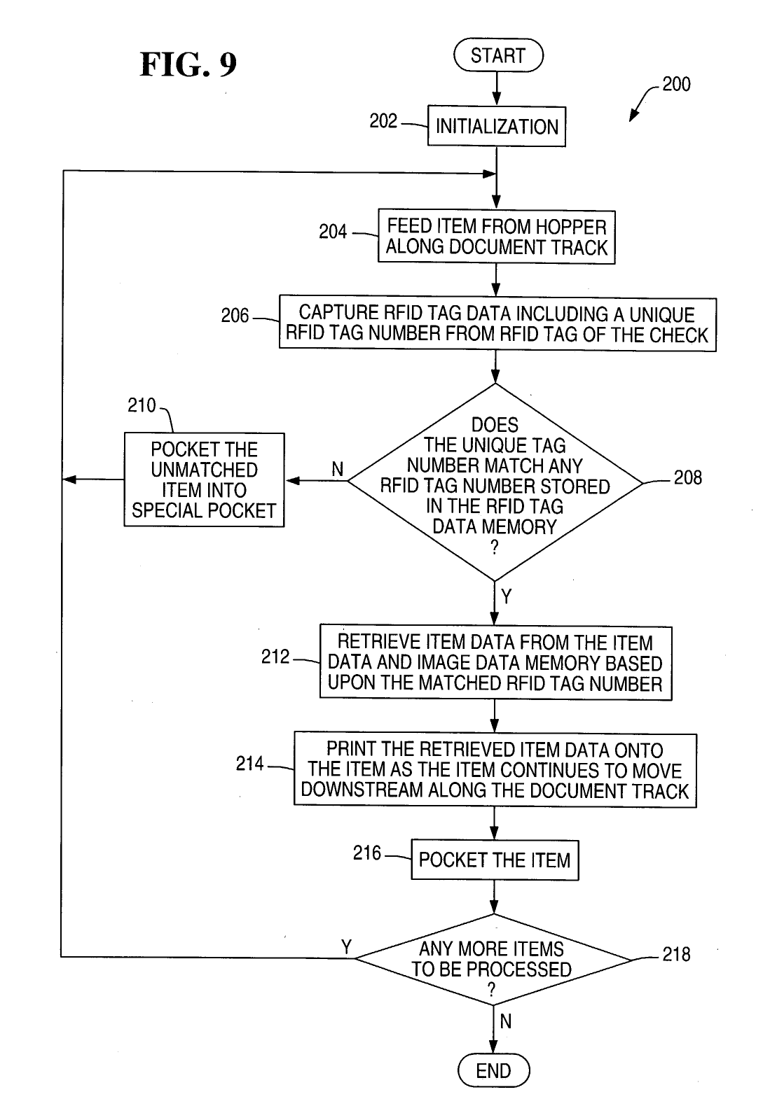

FIG. 9 is a flowchart which depicts operation of the encoding and sorting transport application program 200 which runs continuously as each check is transported from the upstream end of the document transport path 72 towards the downstream end of the document transport path. After program initialization in step 202, the program proceeds to step 204 in which the document feeder 74 feeds checks from the document hopper 73 into the document transport path 72. As shown step 206, the RFID tag reader 76 captures RFID tag data including a unique RFID tag number from each RFID tagged check as the check is transported past the RFID tag reader.

The captured unique RFID tag number is compared with unique RFID tag numbers which were captured at the image capture workstation 14 and stored in the RFID tag data memory 32 (FIG. 2), as shown in step 208, to determine if there is a match. If the determination in step 208 is negative, the program proceeds to step 210 in which the unmatched check is transported along the document transport path 72 into a particular one of the plurality of sorting bins 82 at the end of the document transport path. However, if the determination in step 208 is affirmative, the program proceeds to step 212 in which item data is retrieved from the RFID tag data memory 32. The item data is retrieved based upon the unique RFID tag number which was matched in step 208. This retrieved item data is then printed onto the corresponding check presently being transported along the document transport path 42 as the check continues to move downstream past the encoder 78. The encoding (printing) of the data onto the check is performed in a known manner, as shown in step 214.

Then, a determination is made in step 216 as to whether there are any more checks to be processed at the encoding and sorting workstation 20. If the determination is affirmative, the program returns to step 204 to process the next item in the same manner as just described hereinabove. The program ends if the determination in step 216 is negative.

The encoding and sorting transport 70 further includes an endorser 80 which prints a suitable endorsement in a known manner onto each check as the check continues to move further downstream along the document transport path 72 past the endorser 80. The structure and operation of endorsers are well known and, therefore, will not be described. An endorsement status associated with the check is then stored in the memory unit 31 along with the other information associated with the check. After checks have been processed at the encoding and sorting workstation 20, a small number of exception items (such as free items and missing items) are reconciled at the capture reconciliation workstation 22, as is known.

It should be apparent that the memory unit 31 stores sequence numbers, MICR codelines, and image data associated with transaction items which have been processed in accordance with the image capture transport application program 68 stored in the image capture transport memory 66 during the first pass at the image capture workstation 14. The memory unit 31 also stores encoder status and endorsement status of transaction items which have been processed in accordance with the encoding and sorting transport application program 98 stored in the encoding and sorting transport memory 96 during the second pass at the encoding and sorting workstation 20. The memory unit 32 stores RFID tag data including unique RFID tag numbers captured from checks by the RFID tag reader 46 during the first pass of document items on the image capture workstation 14. The item data encoded onto a particular check during the second pass at the encoding and sorting workstation 20 is based upon the unique RFID tag numbers captured during the first pass at the image capture workstation 14.

A number of advantages are provided by the multiple-pass image-based check processing system 10 in accordance with the present invention. One advantage is that even a check having a MICR codeline which is unable to be read by a MICR reader can be processed as a normal, non-exception item. Another advantage is that even checks having duplicate MICR codelines can be processed as normal, non-exception items. Such checks (i.e., checks having unreadable MICR codelines or checks having duplicate MICR codelines) can be processed as normal, non-exception items because of the fact that each check has its own unique RFID tag number which can be read by an RFID tag reader. Since there are less exception items to deal with, less time is required of human operators to sort through and resolve exception conditions. This results in reduced labor time and, therefore, reduced costs.

Although the above description describes an RFID tag reader located along the document transport path 42 between the document feeder 44 and the codeline reader 48 in the image capture transport 40, and an RFID tag reader located along the document transport path 72 between the document feeder 74 and the encoder 78 in the encoding and sorting transport 80, it is contemplated that the RFID tag readers may be positioned at any location.

Also, although the above description describes the RFID tag data extracting application program 100 and the RFID tag data matching application program 200 as being used in an image-based financial document processing system, it is contemplated that the programs 100, 200 may be used in a non-image-based financial document processing system.

From the above description of the invention, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A multiple-pass item processing system having an image capture workstation for processing checks during a first pass of checks and an encoding and sorting workstation for processing checks during a second pass of checks, the system comprising:
first extracting means for extracting RFID tag data from an RFID tag of a check transported along a check transport path of the image capture workstation during the first pass;
storing means for storing RFID tag data extracted during the first pass;
second extracting means for extracting RFID tag data from an RFID tag of a check transported along a check transport path of the encoding and sorting workstation during the second pass; and
means for comparing the RFID tag data extracted during the second pass with RFID tag data stored in the storing means to determine if there is a match.

2. A system according to claim 1, wherein (i) the first extracting means includes means for extracting RFID tag data including a unique RFID tag number associated with the particular check transported along the check transport path of the image capture workstation during the first pass, and (ii) the second extracting means includes means for extracting RFID tag data including a unique RFID tag number associated with the particular check transported along the check transport path of the encoding and sorting workstation during the second pass.

3. A system according to claim 1, wherein the first extracting means comprises an RFID tag data extracting program.

4. A system according to claim 3, wherein the second extracting means and the comparing means comprises an RFID tag data matching program.

5. A method of operating a multiple-pass item processing system having an image capture workstation for processing checks during a first pass of checks and an encoding and sorting workstation for processing checks during a second pass of checks, the method comprising the steps of:
(a) extracting RFID tag data from an RFID tag of a check transported along a check transport path of the image capture workstation;
(b) extracting RFID tag data from an RFID tag of a check transported along a check transport path of the encoding and sorting workstation; and
(c) comparing the extracted RFID tag data from the encoding and sorting workstation with the extracted RFID tag data from the image and capture workstation to determine if there is a match.

6. A method according to claim 5, further comprising the step of:
(d) storing the extracted RFID tag data from the image capture workstation in an RFID tag data memory.

7. A method according to claim 5, wherein (i) the extracted RFID tag data from the RFID tag of the check transported along the check transport path of the image capture workstation comprises a unique RFID tag number associated with that particular check, (ii) the extracted RFID tag data from the RFID tag of the check transported along the check transport path of the encoding and sorting workstation comprises a unique RFID tag number associated with that particular check, and (iii) the unique RFID tag number from the encoding and sorting workstation is compared with the unique RFID tag number from the image capture workstation.

8. A multiple-pass item processing system for processing checks, the system comprising:
an image capture workstation including (i) means defining a first check transport path along which checks can be transported from an upstream end to a downstream end during a first pass, (ii) a first radio frequency identification (RFID) tag reader disposed along the first check transport path for transmitting interrogating signals toward an RFID tagged check transported along the first check transport path and receiving RFID tag data including a unique RFID tag number from an RFID tag of the check transported along the first check transport path when the check receives an interrogating signal from the first RFID tag reader; and
an encoding and sorting workstation including (i) means defining a second check transport path along which checks can be transported from an upstream end to a downstream end, (ii) a second RFID tag reader disposed along the second check transport path for transmitting interrogating signals toward an RFID tagged check transported along the second check transport path and receiving RFID tag data including a unique RFID tag number from an RFID tag of the check transported along the second check transport path when the check receives an interrogating signal from the second RFID tag reader.

9. A system according to claim 8, wherein the image capture workstation includes an RFID tag data extracting application program for enabling the first RFID tag reader disposed along the first check transport path to transmit interrogating signals toward the RFID tagged check transported along the first check transport path and to receive RFID tag data from the RFID tag of the check transported along the first check transport path when the check receives an interrogating signal from the first RFID tag reader, and thereby to extract RFID tag data from the check.

10. A system according to claim 9, wherein the encoding and sorting workstation includes an RFID tag data extracting application program for (i) enabling the second RFID tag reader disposed along the second check transport path to transmit interrogating signals toward the RFID tagged check transported along the second check transport path and to receive RFID tag data from the RFID tag of the check transported along the second check transport path when the check receives an interrogating signal from the second RFID tag reader, and thereby to extract RFID tag data from the check, and (ii) comparing the extracted RFID tag data with RFID tag data which has been extracted on the first pass at the image capture workstation.

11. An encoding and sorting workstation of a multiple-pass item processing system, the system comprising:
means defining a document transport path along which document items can be transported from an upstream end to a downstream end;
a radio frequency identification (RFID) tag reader disposed along the document transport path, the RFID tag reader including (i) means for transmitting an interrogating signal towards an RFID tagged document item transported along the document transport path, (ii) means for receiving RFID tag data including a unique RFID tag number from an RFID tag of the document item transported along the document transport path when the RFID tag of the document item receives the interrogating signal, and (iii) means for matching the unique RFID tag number with a unique RFID tag number which has been previously captured at a different workstation.

12. A workstation according to claim 11, wherein the matching means comprises an RFID tag data matching program.

13. A method of operating an encoding and sorting workstation of a multiple-pass item processing system, the method comprising the steps of:
transmitting an interrogating signal towards an RFID tag of a document item transported along a document transport path;
receiving RFID tag data including a unique RFID tag number from the RFID tag of the document item transported along the document transport path when the RFID tag of the document item receives the interrogating signal; and
determining if the unique RFID tag number matches a unique RFID tag number which has been previously extracted at a different workstation of the multiple-pass document item processing system.
